(19) United States
(12) Patent Application Publication
(10) Pub. No.: US 2026/0299288 A1
(43) Pub. Date: Oct. 1, 2026

(54) APERTURE TO REDUCE CAMERA FLARE

(71) Applicant: MOTOROLA MOBILITY LLC, WILMINGTON, DE (US)

(72) Inventors: EMILY YANG, CHICAGO, IL (US); MATTHEW BIGGERSTAFF, LIBERTYVILLE, IL (US); JOHN PINCENTI, CHICAGO, IL (US); COLE SHELDON, CHICAGO, IL (US)

(21) Appl. No.: 19/095,152

(22) Filed: Mar. 31, 2025

(51) Int. Cl. G02B 27/00; G02B 5/04; G02B 13/00; G03B 17/17; G03B 30/00

(52) U.S. Cl. CPC G02B 27/0018; G02B 5/04; G02B 13/0065; G03B 17/17; G03B 30/00

(57) ABSTRACT

Disclosed embodiments provide a camera assembly that enables features for reducing camera flare that can be prevalent in cameras having folded optics. The camera assembly can include a prism, where the prism is disposed between a lens and image sensor. An aperture that includes nonlinear interior surfaces is disposed in an incident portion of the folded light path. The nonlinear interior surfaces serve to dissipate the point spread function, thereby reducing the adverse effects of camera flare in acquired images.

### BACKGROUND

### 1. Technical Field

The present disclosure generally relates to cameras, and more specifically to cameras utilizing folded optics.

### 2. Description of the Related Art

Cameras in portable electronic devices such as smartphones and tablets have evolved far beyond basic photography, becoming versatile tools that enhance both everyday life and specialized tasks. Cameras in electronic devices can enable high-quality photo and video capture, making it easy to document memories, share content on social media, or engage in video calls with friends and colleagues. Beyond that, these cameras can support advanced features such as facial recognition for secure unlocking of an electronic device based on biometric features, augmented reality (AR) experiences that overlay digital elements onto the real world, and quick response (QR) code scanning for quick access to websites, payments, and information, and other features. For communication applications, these cameras can facilitate remote work with video conferencing. Content creators can also benefit from high-resolution recording provided by these cameras. Additionally, cameras play a critical role in accessibility, such as helping visually impaired users identify objects and navigate environments. As mobile cameras continue to improve, these cameras are becoming indispensable for productivity, entertainment, and personal security.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 is a diagram of an enclosure for a camera assembly, according to one or more embodiments;

FIG. 3 is a diagram of a camera assembly, illustrating a prism causing a straight edge aperture effect;

FIG. 4 shows examples of apertures with nonlinear interior surfaces, according to one or more embodiments;

FIG. 5A shows details of a nonlinear interior surface of an aperture, according to one or more embodiments;

FIG. 5B shows details of a nonlinear interior surface of an aperture indicating varying amplitude, according to one or more embodiments;

FIG. 5C shows details of a nonlinear interior surface of an aperture indicating varying frequency, according to one or more embodiments;

FIG. 5D shows details of a nonlinear interior surface of an aperture indicating varying amplitude and varying frequency, according to one or more embodiments;

FIG. 5E shows details of a nonlinear interior surface of an aperture indicating varying ridge shapes, according to one or more embodiments;

FIG. 6 is a diagram of a camera assembly using an aperture with nonlinear interior surfaces, according to one or more embodiments;

FIG. 7 shows examples of various apertures and corresponding lens flare, according to one or more embodiments; and

FIG. 8 is a flowchart indicating steps for manufacturing a camera assembly using an aperture with nonlinear interior surfaces, according to one or more embodiments.

### DETAILED DESCRIPTION

According to aspects of the present disclosure, a camera assembly provides features for reducing camera flare that can be prevalent in cameras having folded optics. The folded optics can include a prism, where the prism is disposed between a lens and an image sensor. An aperture that includes nonlinear interior surfaces is disposed in an incident portion of the folded light path. The nonlinear interior surfaces serve to dissipate the point spread function that is caused by traditional straight prism edges, thereby reducing the adverse effects of camera flare in acquired images.

Implementing camera optics in compact electronic devices such as smartphones and tablets presents significant engineering challenges, particularly due to the limited space available for traditional lens systems. To address the limited space issue, manufacturers increasingly rely on folded optics, which is a design approach that can use prisms to “fold” the light path, allowing longer focal lengths within a slim device profile. The folded optics approach supports advanced features such as telephoto zoom without significantly increasing the camera bump size. However, folded optics introduce unique optical complications. One major issue arises from the abrupt edges at the prism edges, which can disturb the light's path, leading to a concentrated Point Spread Function (PSF).

A concentrated PSF results in light being focused too sharply in certain regions, producing visual artifacts such as distortions and/or uneven sharpness in captured images. These artifacts can degrade image quality, especially in high-contrast scenes or low-light conditions where clarity is critical. Limited correction of these artifacts may be accomplished via complex image processing techniques, such as deconvolution algorithms or AI-based sharpening, but these techniques can add computational overhead and may still fall short of restoring the true image fidelity. Balancing compactness, image quality, and manufacturing efficiency remains a demanding task for designers of cameras in mobile electronic devices.

The disclosed embodiments mitigate the aforementioned issues by providing an improved camera assembly for mobile devices that incorporates an aperture with nonlinear interior surfaces. This improved camera assembly offers significant benefits in image quality and design efficiency. By using an aperture that has nonlinear interior surfaces that vary in frequency and/or amplitude, the assembly produces a more dissipated Point Spread Function (PSF). This diffusion helps scatter incoming light more evenly, reducing the intensity of concentrated light artifacts that typically lead to flare and/or distortion. As a result, images captured in challenging lighting conditions, such as bright backlighting or night scenes with streetlights, can exhibit clearer, more accurate representations of the scene, with fewer distracting artifacts.

One of the more compelling advantages of the disclosed embodiments is that they mitigate flare at the optical level, reducing the need for complex, resource-intensive image processing corrections. Thus, disclosed embodiments not only preserve the device's processing power and battery life for other tasks, but also ensure that images maintain a more natural appearance without over-smoothing or detail loss from digital correction algorithms. Additionally, the nonlinear aperture design is relatively straightforward to manufacture using existing materials and fabrication techniques, making it an economical upgrade. Disclosed embodiments can be integrated into smartphones and tablets without significantly increasing production costs or device thickness, which is a critical factor in maintaining the sleek, portable designs that consumers have come to expect.

One or more embodiments can provide an electronic device that includes: at least one image capturing device comprising: a lens; an image sensor; a prism disposed between the lens and the image sensor, wherein the prism forms a folded light path between the lens and the image sensor. The image capturing device further comprises an aperture disposed in an incident portion of the folded light path, wherein the aperture includes nonlinear interior surfaces.

One or more embodiments can provide a camera assembly, comprising: a prism configured to be disposed between a lens and an image sensor, wherein the prism forms a folded light path between the lens and the image sensor; and an aperture disposed in an incident portion of the folded light path, wherein the aperture includes nonlinear interior surfaces.

One or more embodiments can provide a method for manufacturing a camera lens assembly, the method including: disposing a prism within an enclosure, wherein the enclosure comprises a first opening, and a second opening, wherein the first opening and second opening are oriented perpendicularly to each other, with the prism internally located to provide a folded light path between the first opening and the second opening; disposing a lens that covers the first opening; and disposing an aperture within an incident path of the folded light path, wherein the aperture includes nonlinear interior surfaces.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

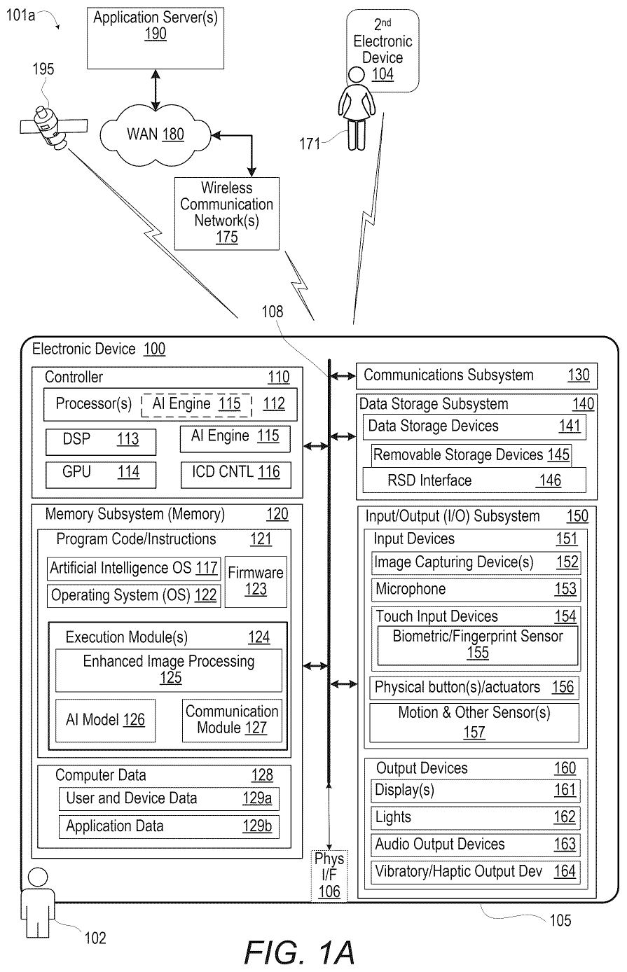

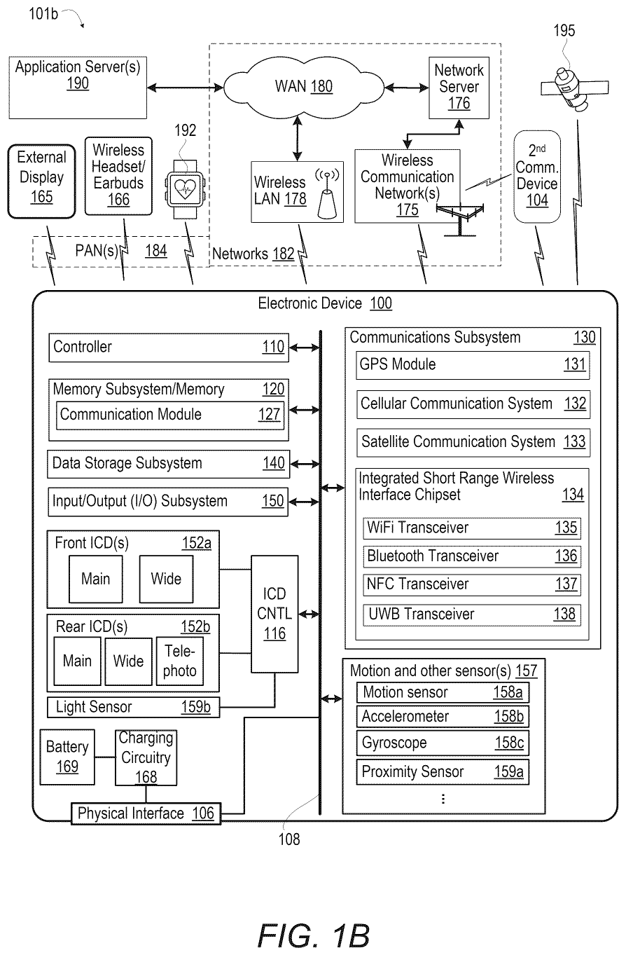

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device 100 is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that can include native support for AI-specific hardware such as Neural Processing Units (NPUs) or Tensor Processing Units (TPUs) to optimize performance for AI tasks such as machine learning inference and training.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, image processing module 125, which provides the features and operating functionality of the disclosed embodiments when the corresponding program instructions of image processing module 125 are processed by/within processor 112/controller 110.

Execution modules 124 further includes AI model(s) 126. In one or more embodiments, processor 112 can utilize AI models 126 to provide AI functionality of processor-integrated AI engine 115. In other embodiments, AI models 126 are directly utilized by AI engine 115. In one or more embodiments, AI model(s) 126 is integrated as a sub-module within image processing module 125 and is trained to support AI features of image processing module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, image processing module 125 can include program instructions that cause or configure processor 112 to cause electronic device 100 to adjust focus, adjust focal length, and/or adjust other parameters related to cameras, camera optics, and the like.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of image processing module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by a user to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive a user's tactile/touch input. As a touch screen device, integrated display 161 allows a user to provide input to and/or to control electronic device 100 by touching features within a user interface presented on integrated display 161. Tactile, touch input device 154 can include a touch screen interface. The touch screen interface can include one or more virtual buttons or selectable affordances. In one or more embodiments, when a user 102 applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device 100 to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRx) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of image processing module 125 and/or access to other applications, online transactions, and resources. In one or more embodiments, networks 182 can also include personal area networks (PAN) 184, which are individually created with second devices via one of short-range wireless devices from among Wi-Fi TxRx 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition. According to aspects of the present disclosure, one or more of front cameras 152a and rear cameras 152b are configured to utilize a camera assembly that includes an aperture with nonlinear interior surfaces, as described in additional detail in the following paragraphs and figures.

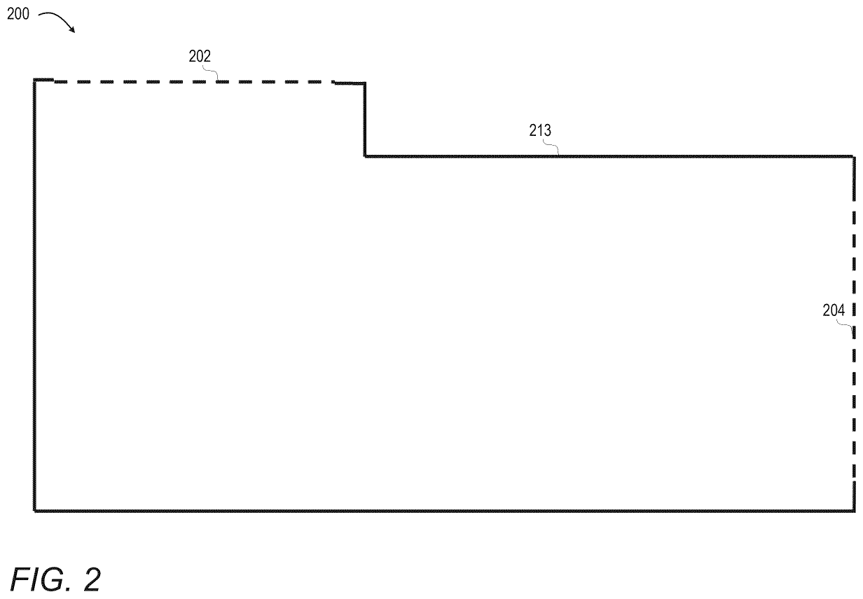

FIG. 2 is a diagram of an enclosure for a camera assembly, according to one or more embodiments. Enclosure 200 includes enclosure walls, indicated generally as 213. In the provided embodiments, the enclosure walls can be comprised of metal, plastic, or other suitable materials. A first opening 202 is formed at one end of the enclosure, and a second opening 204 is formed at an opposite end of the enclosure. In embodiments, the first opening and second opening are oriented perpendicularly to each other. Thus, as can be seen in FIG. 2, the enclosure is L-shaped. An L-shaped enclosure with a first opening at one end and a second opening at the other, oriented perpendicularly to each other, provides a practical solution for implementing folded optics in space-constrained devices such as smartphones (e.g., electronic device 100) and tablets. This configuration allows light to enter through the first opening, travel along one arm of the L-shape enclosure, and then be redirected by a prism or mirror at the corner, guiding the light toward the second opening, where an image sensor is positioned. By folding the light path in this way, the camera assembly can achieve a longer effective focal length without requiring additional depth, which is crucial for maintaining slim, lightweight device designs. Lenses, sensors, and other optical components can be strategically placed within or around the L-shaped enclosure to further refine image capture, enabling features such as telephoto zoom or high-resolution imaging in a compact footprint.

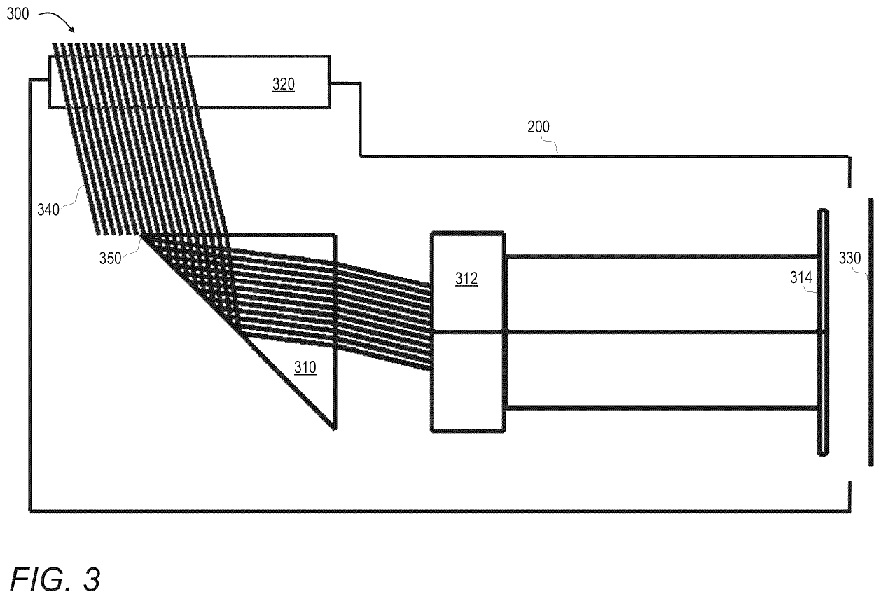

FIG. 3 is a diagram of a camera assembly, illustrating a prism causing a straight edge aperture effect. Camera assembly 300 includes enclosure 200. Camera assembly 300 includes an objective lens 320. The objective lens 320 can be disposed in the first opening 202 of the enclosure 200. In some embodiments, the objective lens 320 can serve as the main lens that collects light. In folded optics, the objective lens 320 can be designed to be compact and may comprise multiple plastic or glass elements to correct for distortions and/or improve clarity. Camera assembly 300 further includes prism 310. In one or more embodiments, the prism 310 redirects light 90 degrees, allowing a major portion of the camera's focal length to be oriented parallel to the phone's body to achieve a long focal length without excessive lens protrusion from the phone body. The camera assembly 300 can further include a collimating lens 312 which can serve to straighten the light path, improving focus and reducing aberrations. The camera assembly 300 can further include a focusing lens 314, which can be adjusted to ensure sharp image projection onto the sensor 330. Light/image sensor 330 can be disposed in or proximal to, the second opening 204 of FIG. 2). In one or more embodiments, the sensor 330 can include a CMOS sensor, Bayer sensor, and/or other suitable sensor. The arrangement shown in FIG. 3 allows for features such as periscope zoom, which can provide various optical zoom ranges (e.g., 5× or 10×) without needing a large protruding lens.

As shown in FIG. 3, incident light 340 passes through objective lens 320, where the light 340 is directed onto prism 310. An interface with straight edges is formed at the edge 350 of the prism 310. Light 340 that strikes this edge 350 causes a PSF that is concentrated in directions perpendicular to this straight edge interface, creating a noticeable flare pattern that is undesirable in most cases. The Point Spread Function (PSF) significantly impacts how lens flare appears in digital images, particularly when dealing with bright light sources like streetlights, headlights, or the sun. The starburst or cross pattern effect is particularly common when light passes through sharp edges or transitions between optical elements, which is a scenario frequently encountered in folded optics designs that rely on prisms to redirect light in compact smartphone cameras. The abrupt surfaces of these prisms introduce sharp, high-frequency components into the PSF, creating directional spikes of light radiating from the source. This type of flare can degrade image quality, reducing contrast and making nighttime or high-contrast photos appear messy or cluttered. To mitigate this, disclosed embodiments use an aperture with nonlinear interior surfaces, to effectively remove the edges, and create a less concentrated PSF, thereby improving overall image quality.

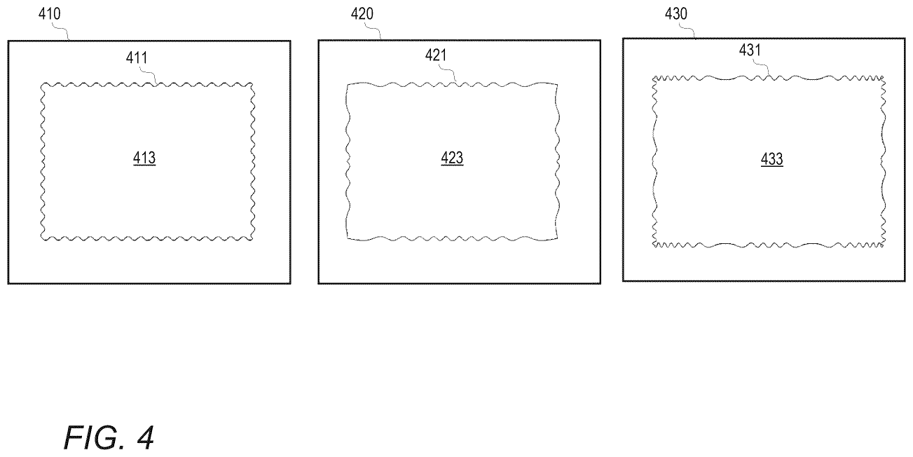

FIG. 4 shows examples of apertures with nonlinear interior surfaces, according to one or more embodiments. The nonlinear interior surfaces can serve to disperse an undesirable flare pattern, thereby improving image quality, especially in images that contain objects that emit light, such as headlights, streetlights, lamps, and so on. Aperture 410 includes nonlinear interior surface 411. The nonlinear interior surface 411 includes a pattern of ridges. In embodiments, the ridges can have a sinusoidal shape or profile. Light can pass through the aperture opening 413. Aperture 420 includes nonlinear interior surface 421. The nonlinear interior surface 421 includes a pattern of ridges of varying frequency. Light can pass through the aperture opening 423. Aperture 430 includes nonlinear interior surface 431. The nonlinear interior surface 431 includes a pattern of ridges of varying frequency, where the amount of frequency variation is greater than the frequency variation in nonlinear surface 421 of aperture 420. Light can pass through the aperture opening 433. Other patterns of the nonlinear interior surface are possible in disclosed embodiments. One or more embodiments can include variations in amplitude and/or frequency. In some embodiments, the nonlinear interior surface of the aperture may include a randomized pattern. In the presented embodiments, the aperture includes a generally rectangular outer form factor.

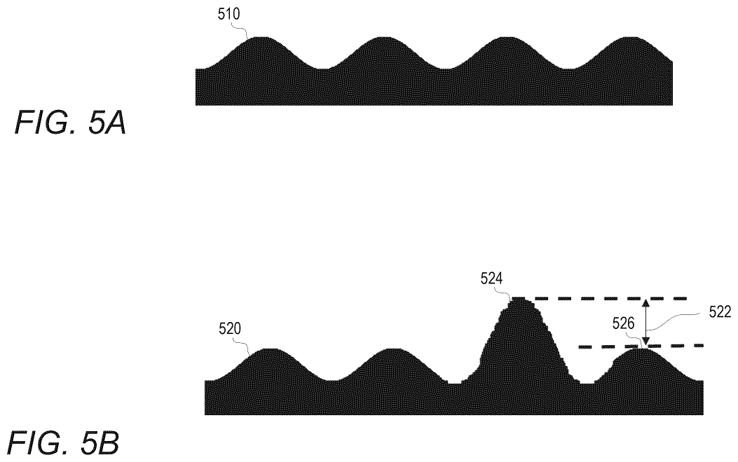

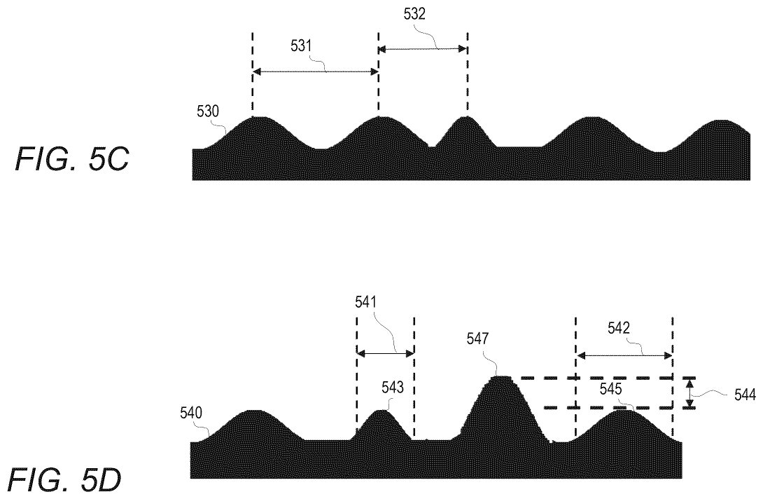

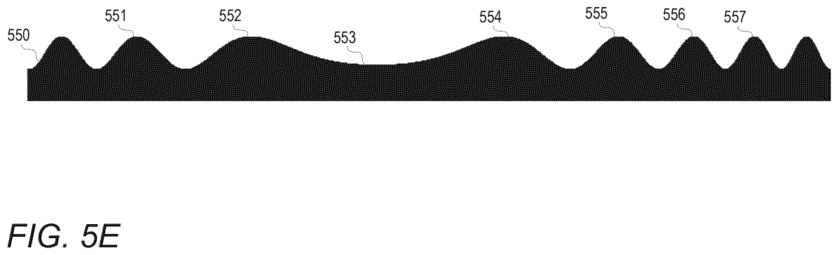

FIG. 5A shows details of a nonlinear interior surface of an aperture, according to one or more embodiments. Nonlinear surface 510 may resemble a sinusoidal wave of a given frequency and amplitude. FIG. 5B shows details of a nonlinear interior surface 520 of an aperture indicating varying amplitude, according to one or more embodiments. Nonlinear surface 520 includes a variation in amplitude indicated at 522, where ridge 524 is of a greater amplitude than ridge 526. In some embodiments, the nonlinear interior surfaces include ridges of varying amplitude. FIG. 5C shows details of a nonlinear interior surface of an aperture indicating varying frequency, according to one or more embodiments. Nonlinear surface 530 includes two adjacent ridge peaks spaced apart by a first distance 531 and also includes two adjacent ridge peaks spaced apart by a second distance 532. In the presented embodiments, first distance 531 is greater than second distance 532. Accordingly, the frequency of the pattern of nonlinear surface 530 varies. In some embodiments, the nonlinear interior surfaces include ridges of varying frequency. FIG. 5D shows details of a nonlinear interior surface of an aperture indicating varying amplitude and varying protrusion width, according to one or more embodiments. Surface 540 includes a first ridge 543 having a first width 541 and a second ridge 545 having a second width 542. In the presented embodiments, the second width 542 is greater than the first width 541. Moreover, nonlinear surface 540 also has ridges of varying amplitude. Ridge 547 has a greater amplitude than ridge 545. The difference in amplitude between ridge 547 and ridge 545 is indicated at 544. In one or more embodiments, the amplitude ranges from 0.1 millimeters to 0.5 millimeters, and a peak-to-peak distance between the ridges ranges from 0.4 millimeters to 0.7 millimeters. FIG. 5E shows details of a nonlinear interior surface of an aperture indicating varying peak shapes, according to one or more embodiments. Nonlinear surface 550 includes a ridge 551 and an adjacent ridge 552. Ridge 552 is smoothed such that it joins with adjacent smoothed ridge 554, forming a trough 553 disposed between ridge 552 and ridge 554. Ridge 555 is adjacent to ridge 554, ridge 556 is adjacent to ridge 555, and ridge 557 is adjacent to ridge 556. One or more embodiments can include ridges of varying amplitudes, frequencies, and widths. Moreover, the nonlinear surfaces of disclosed embodiments can include a trough disposed between one or more sets of adjacent ridges, such as shown at 553 in FIG. 5E. In embodiments, the nonlinear interior surfaces include ridges of varying frequency and varying amplitude. The nonlinear interior surfaces of disclosed embodiments offer a significant advantage by improving image quality without requiring additional computational post-processing, keeping power consumption and hardware costs low, which are both very important factors in the design of electronic devices such as smartphones and tablet computers.

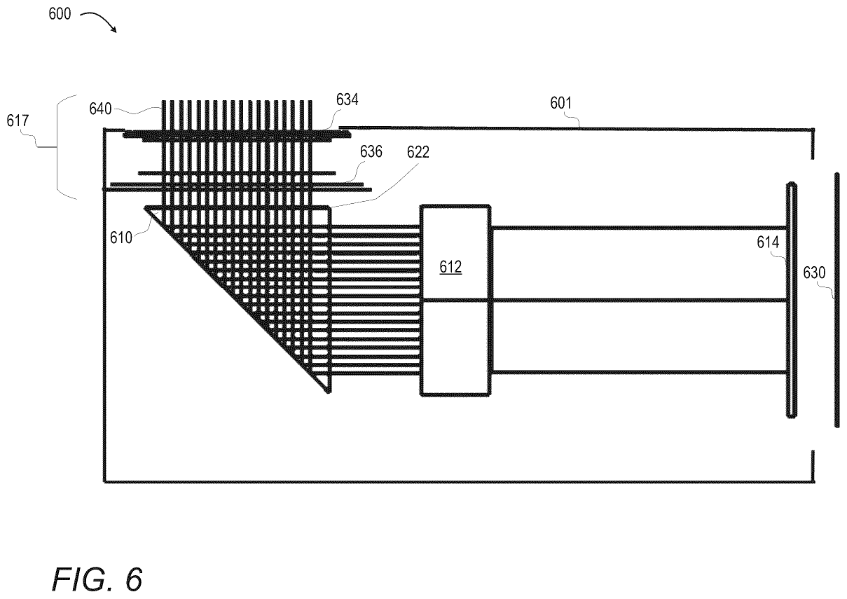

FIG. 6 is a diagram of a camera assembly using an aperture with nonlinear interior surfaces, according to one or more embodiments. Similar to camera assembly 300 of FIG. 3, camera assembly 600 includes enclosure 601. In some embodiments, enclosure 601 may be similar to enclosure 200 shown in FIG. 2. Camera assembly 600 includes an objective lens 634. The objective lens 634 can be disposed in the first opening (e.g., 202 of FIG. 2) of the enclosure 601. Camera assembly 600 further includes prism 610. In one or more embodiments, the prism 610 redirects light 90 degrees, allowing a major portion of the camera's focal length to be oriented parallel to the phone's body to achieve a long focal length without excessive lens protrusion from the phone body. Embodiments can include an aperture disposed in an incident portion 617 of the folded light path, where the aperture includes nonlinear interior surfaces. The camera assembly 600 can further include a collimating lens 612 which can serve to straighten the light path, improving focus and reducing aberrations. The camera assembly 600 can further include a focusing lens 614, which can be adjusted to ensure sharp image projection onto the sensor 630. Sensor 630 can be disposed in or be proximal to the second opening (e.g., 204 of FIG. 2). In one or more embodiments, the sensor 630 can include a CMOS sensor, Bayer sensor, and/or other suitable sensor. One or more embodiments can include a prism disposed between the lens and the image sensor, where the prism forms a folded light path between the lens and the image sensor. As shown in FIG. 6, aperture 636 is disposed in the incident portion 617 of the folded light path, such that the light does not reach the edge of the prism 610, as compared with light 340 impinging on edge 350 as shown in FIG. 3. Thus, incident light 640 passes through objective lens 634, and is directed onto prism 610. The incident of light striking straight edges of the prism (such as shown in FIG. 3) is eliminated by use of the aperture 636. In one or more embodiments, the aperture 636 may be similar to aperture 410, aperture 420, or aperture 430 shown in FIG. 4. While in FIG. 6 the aperture 636 is shown mounted above prism 610, in some embodiments, the aperture is disposed on the prism 610. The aperture may be affixed to the prism via adhesives or printed directly onto the prism incident surface 622 using an ink. Thus, in embodiments, the aperture is imprinted on a substrate within the incident portion of the folded light path with an ink. The ink can be a black ink, brown ink, gray ink, or other suitable color/shade of ink.

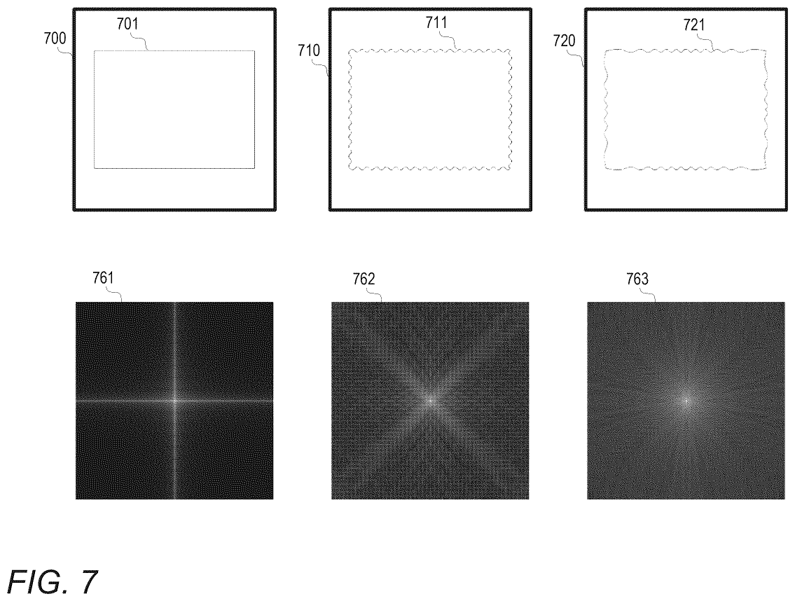

FIG. 7 shows examples of various apertures and corresponding lens flare, according to one or more embodiments. Aperture 700 is a standard aperture having a linear interior surface 701. The corresponding lens flare pattern 761 that corresponds to aperture 700 is also shown. As can be seen in lens flare pattern 761, a distinct “cross” pattern can be observed. The concentration of light along both the vertical and horizontal axes can cause unwanted interference in an acquired image. Aperture 710 has nonlinear interior surface 711 that includes periodic variations. The corresponding lens flare pattern 762 that corresponds to aperture 710 is also shown. As can be seen in lens flare pattern 762, the light is dispersed more than as compared with lens flare pattern 761. Aperture 720 has nonlinear interior surface 721 that includes aperiodic variations. The corresponding lens flare pattern 763 that corresponds to aperture 720 is also shown. As can be seen in lens flare pattern 763, the light is dispersed even more than as shown in lens flare pattern 762. Thus, disclosed embodiments can avoid the undesirable lens flare, such as shown in lens flare pattern 761.

The nonlinear interior surfaces in apertures of disclosed embodiments can impact the Point Spread Function (PSF) by altering how light is distributed across the image sensor. In a traditional aperture with linear surfaces (e.g., aperture 700), light entering the camera can strike prism edges, often leading to concentrated points of light, especially from bright sources such as headlights or streetlights. The light striking straight edges within a camera assembly can cause unwanted flare and halos in captured images. When nonlinear surfaces are introduced, such as shown at 711 and 721, the nonlinear surfaces modify the path and distribution of incoming light rays. Instead of allowing light to converge sharply at specific points, these nonlinear interior surfaces can diffuse and spread the light more evenly. By doing so, the nonlinear surfaces help to disperse the intensity of light from bright sources, reducing flare and minimizing the formation of bright spots that can obscure details in the image. The effect on the PSF is that the central peak of the function, representing the light intensity at a particular point, becomes less pronounced, and the light can be distributed more uniformly across the sensor. This diffused PSF can result in a smoother transition of light intensities, enhancing the overall image quality by preserving details and contrast, especially in scenes with high dynamic range. Thus, the nonlinear interior surfaces of disclosed embodiments can improve image quality by preventing sharp light concentration, leading to clearer and more balanced images with reduced flare from bright light sources.

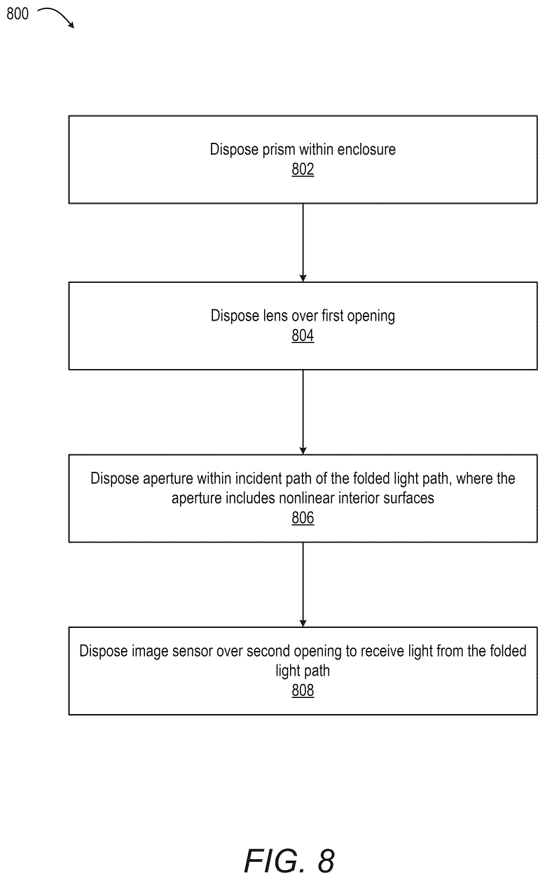

Referring now to the flowcharts presented by FIG. 8, the descriptions of the methods in FIG. 8 are provided with general reference to the specific components and features illustrated within the preceding FIGS. 1-7. Specific components referenced in the methods of FIG. 8 may be identical or similar to components of the same name used in describing preceding FIGS. 1-7.

FIG. 8 is a flowchart indicating steps for manufacturing a camera assembly using an aperture with nonlinear interior surfaces, according to one or more embodiments. The method 800 starts at block 802, where a prism is disposed within an enclosure, such as shown at 610 in FIG. 6. In embodiments, the enclosure is an L-shaped enclosure and the prism can include a right-angle prism, disposed at the interior corner position of the L-shaped enclosure. The method 800 includes disposing a lens over the first opening at block 804. The method 800 continues to block 806, and includes disposing an aperture within the incident portion of the folded light path, where the aperture includes nonlinear interior surfaces, such as the nonlinear interior surface shown in FIG. 4 and FIG. 5A-FIG. 5E. The aperture can be disposed on a surface of the prism or proximate to the outlet surface of the prism, in different embodiments. The method 800 continues to block 808 where an image sensor is disposed over the second opening to receive light from the folded light path. The camera assembly that can be manufactured by the method 800 can provide advantages of dissipating a lens flare pattern so that the lens flare pattern is not as prominent in an acquired image, as compared with images acquired from a camera that uses a camera assembly that has an aperture that includes linear interior surfaces.

The flowcharts, sequences, and configurations presented herein are provided solely for illustrative purposes and are exemplary in nature. These embodiments are not intended to be limiting and may include variations with more, fewer, and/or alternative options, sequences, or features as would be apparent to those skilled in the art.

As can now be appreciated, disclosed embodiments provide an aperture with nonlinear interior surfaces in a folded optics camera assembly that can provide significant benefits for electronic devices such as smartphones and tablets. One of the primary advantages is the alteration of the Point Spread Function (PSF), which effectively mitigates concentrated lens flare from light-emitting objects such as headlights, streetlights, and other bright sources. By redistributing the light in a more controlled manner, the nonlinear surfaces can diffuse the intense light that can cause flare, resulting in a clearer and more evenly lit image. This reduction in camera flare can greatly enhance overall image quality by preserving the integrity of the captured scene. The nonlinear surfaces ensure that the light is spread more uniformly across the image sensor, which can result in improved overall image quality. The features of disclosed embodiments can be particularly beneficial in low-light conditions and high-dynamic-range (HDR) imaging, where precise light management is crucial. Thus, incorporating an aperture with nonlinear interior surfaces in folded optics camera assemblies can help achieve superior photographic results, making apertures of disclosed embodiments a useful component for imaging technology in portable electronic devices.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one image capturing device comprising:
a lens;
an image sensor;
a prism disposed between the lens and the image sensor, wherein the prism forms a folded light path between the lens and the image sensor; and
an aperture disposed in an incident portion of the folded light path, wherein the aperture includes nonlinear interior surfaces.

2. The electronic device of claim 1, wherein the aperture includes a generally rectangular outer form factor.

3. The electronic device of claim 2, wherein the nonlinear interior surfaces include ridges of varying amplitude.

4. The electronic device of claim 2, wherein the nonlinear interior surfaces include ridges of varying frequency.

5. The electronic device of claim 2, wherein the nonlinear interior surfaces include ridges of varying frequency and varying amplitude.

6. The electronic device of claim 5, wherein the amplitude ranges from 0.1 millimeters to 0.5 millimeters, and wherein a peak-to-peak distance between the ridges ranges from 0.4 millimeters to 0.7 millimeters.

7. The electronic device of claim 1, wherein the aperture is disposed on the prism.

8. The electronic device of claim 7, wherein the aperture is imprinted on a substrate within the incident portion of the folded light path with an ink.

9. A camera assembly, comprising:
a prism configured to be disposed between a lens and an image sensor, wherein the prism forms a folded light path between the lens and the image sensor; and
an aperture disposed in an incident portion of the folded light path, wherein the aperture includes nonlinear interior surfaces.

10. The camera assembly of claim 9, wherein the aperture includes a generally rectangular outer form factor.

11. The camera assembly of claim 10, wherein the nonlinear interior surfaces include ridges of varying amplitude.

12. The camera assembly of claim 11, wherein the nonlinear interior surfaces include ridges of varying frequency.

13. The camera assembly of claim 11, wherein the amplitude ranges from 0.1 millimeters to 0.5 millimeters, and wherein a peak-to-peak distance between the ridges ranges from 0.4 millimeters to 0.7 millimeters.

14. The camera assembly of claim 10, wherein the nonlinear interior surfaces include ridges of varying frequency.

15. The camera assembly of claim 13, wherein the aperture is disposed on the prism.

16. The camera assembly of claim 15, wherein the aperture is comprised of ink.

17. A method for manufacturing a camera lens assembly, the method comprising:
disposing a prism within an enclosure, wherein the enclosure comprises a first opening, and a second opening, wherein the first opening and second opening are oriented perpendicularly to each other, thereby forming a folded light path;
disposing a lens that covers the first opening; and
disposing an aperture within an incident portion of the folded light path, wherein the aperture includes nonlinear interior surfaces.

18. The method of claim 17, wherein disposing an aperture within an output path of the folded light path comprises printing the aperture on the prism using ink.

19. The method of claim 18, wherein the aperture includes a generally rectangular outer form and the nonlinear interior surfaces include ridges of varying amplitude.

20. The method of claim 19, wherein the amplitude ranges from 0.1 millimeters to 0.5 millimeters, and wherein a peak-to-peak distance between the ridges ranges from 0.4 millimeters to 0.7 millimeters.
